(19) United States
(12) Patent Application Publication
(10) Pub. No.: US 2006/0088798 A1
(43) Pub. Date: Apr. 27, 2006

(54) Light tip for dental use

(76) Inventors: Richard E. Feinbloom, New York, NY (US); Kenneth Braganca, Floral Park, NY (US)

Correspondence Address: PLEVY & HOWARD, P.C., P.O. BOX 226, FORT WASHINGTON, PA, 19034, US

(21) Appl. No.: 11/257,893

(22) Filed: Oct. 25, 2005

Related U.S. Application Data
(60) Provisional application No. 60/621,959, filed on Oct. 25, 2004.

(51) Int. Cl. A61C 3/00

(52) U.S. Cl. 433/29

(57) ABSTRACT

A light tip has a bundle of optical fibers extending from a proximal light-transmitting aperture to a distal light-transmitting aperture and an opaque sleeve about the bundle. The proximal light transmitting aperture has a first cross-sectional shape and the distal light transmitting aperture has a second cross-sectional shape. At least some of the optical fibers in the bundle taper from a relatively larger diameter at the proximal aperture to a relatively smaller diameter at the distal aperture. The surface area of the proximal aperture is greater than the surface area of the distal aperture. The cross-sectional shape of the light tip smoothly and continuously changes from the first cross-sectional shape to the second cross-sectional shape through at least a first portion of the light tip. The light tip has a curved section intermediate the proximal and distal apertures.

### RELATED APPLICATIONS

This application claims the benefit of U.S. Provisional Patent Application No. 60/621,959, filed Oct. 25, 2004, which application is incorporated herein by reference in its entirety.

### FIELD OF INVENTION

The present invention relates to light tips for dental use.

### BACKGROUND

Light tips are used in dental applications to convey optical radiation from an emitter to the mouth for curing dental adhesives and other materials for dental use. Such light tips generally include a circular proximal aperture for receiving light from a source, a bundle of optical fibers that receive light from the proximal aperture and are tapered to a circular distal aperture to reduce the size of the distal aperture and better concentrate the radiation. Prior art light tips have a bend to better permit the distal aperture to be placed adjacent a tooth.

### SUMMARY OF THE INVENTION

A light tip has a bundle of elongated light conductors and a sleeve about the bundle. The light tip has a proximal light transmitting aperture having a first cross-sectional shape and a distal light transmitting aperture having a second cross-sectional shape. At least some of the elongated light conductors in the bundle taper from a relatively larger diameter to a relatively smaller diameter from the proximal aperture to the distal aperture. The surface area of the proximal aperture is greater than the surface area of the distal aperture. The cross-sectional shape of the light tip may smoothly and continuously change from the first cross-sectional shape to the second cross-sectional shape through at least a first portion of the light tip. The light tip may have two straight sections and a curved section intermediate the straight sections.

### BRIEF DESCRIPTION OF THE DRAWINGS

FIG. 1 is an isometric view of a light tip in accordance with an embodiment of the invention.

FIG. 2 is a schematic side view of the light tip of FIG. 1.

FIG. 3 is an elevational view of the proximal end of the light tip of FIG. 1.

FIG. 4 is an elevational view of the distal end of the light tip of FIG. 1.

FIG. 5 is a schematic view showing a range of angles of taper on the light tip of FIG. 1.

FIG. 6 is a side elevational view of a light tip of FIG. 1 prior to bending.

FIG. 7 is an elevational view, rotated 90 degrees from the view of FIG. 6, of a light tip of FIG. 1 prior to bending.

FIG. 8 is an elevational view of an optical fiber of the type contained in the light tip shown in FIG. 6.

FIG. 9 is a process flow diagram of a process of making a bundle of elongated conductors for use in a light tip in accordance with an embodiment of the invention.

### DETAILED DESCRIPTION

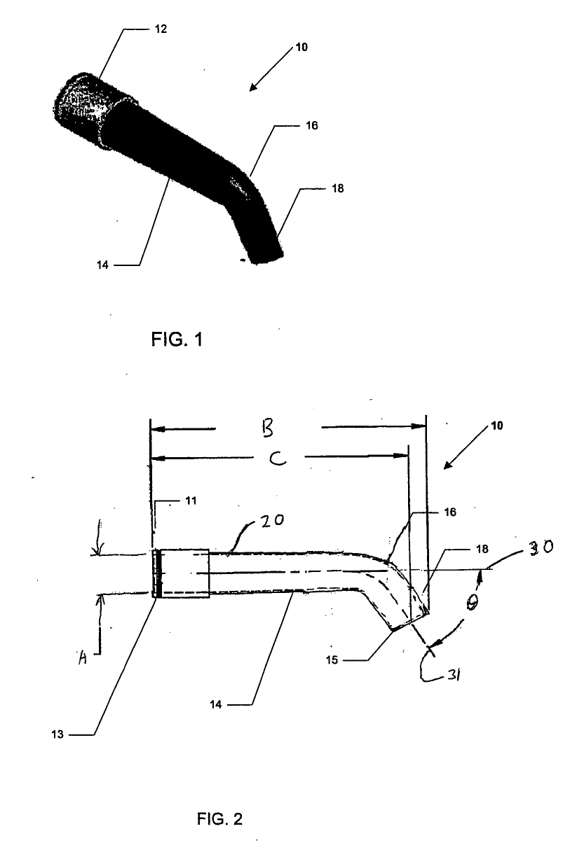

Referring to FIGS. 1 and 2, an embodiment of the invention will now be described. Light tip 10 is shown. Light tip 10 has a proximal collar 12, a first straight section 14 extending distally from proximal collar 12, a curved section 16 extending distally from first straight section 14, and a second straight second 18 extending from the distal end of curved section 16.

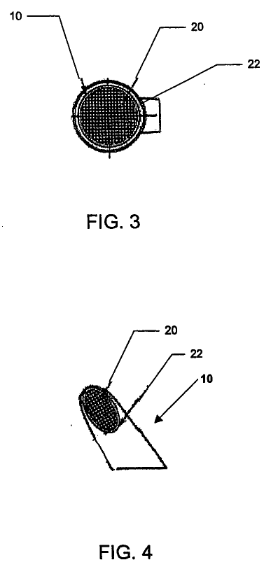

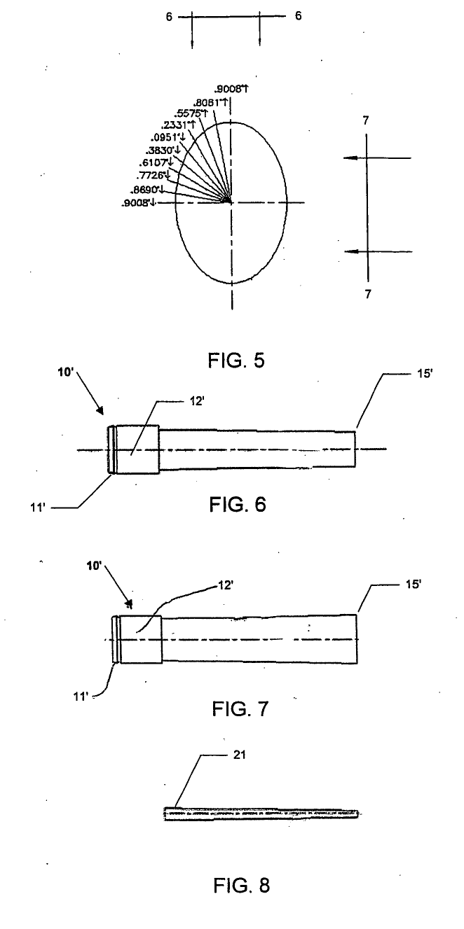

Light tip 10 has a bundle 20 of elongated light conductors, which may be optical fibers, surrounded by a conforming opaque sleeve 22, which may be a cladded covering. Bundle 20 is indicated in dashed lines in FIG. 2, and the ends of the elongated light conductors making up bundle 20 are seen in FIGS. 3 and 4. Each of the elongated light conductors extends from the proximal end of the bundle to the proximal end of the bundle.

At least some of the optical fibers making up the bundle 20 taper from a relatively larger diameter at the proximal end 11 of the light tip to a relatively smaller diameter at the distal end 15 of the light tip 10. An exemplary tapered optical fiber 21 is shown in FIG. 8. All of optical fibers making up bundle 20 may be gradually tapered from the proximal end of the light tip to the distal end of the light tip. The optical fibers may have a diameter of about 100 microns at the proximal end, and a diameter of about 60 microns at the distal end. Bundle 20 may contain about 1600 optical fibers. The taper angle of the individual fibers is a function of the number of fibers and the taper of the bundle, and may be about 0.75 degrees, for example. The taper may extend the entire length of the light tip 10, or a lesser length.

Although the taper results in some losses, the taper serves to concentrate the light energy received at the proximal end 11 to cover an opening having a smaller area at the distal end 15. By concentrating the energy, a higher intensity of radiation is output at the distal end 15, which can speed the curing of light-curable materials such as dental adhesives.

The proximal end 11 of the light tip 10 has a first cross-sectional shape, which in the illustrated embodiment is circular, as shown in FIG. 3. The cross-sectional shape of the proximal end 11 is selected to receive input radiation, and a circular shape is generally desirable. However, other shapes may be selected.

The distal end 15 of the light tip 10 has a second cross-sectional shape. In the illustrated embodiment, as may be seen in FIG. 4, the distal end 15 of the light tip 10 has an elliptical cross-sectional shape. The elliptical shape is advantageous in that the shape better conforms to the shape of a tooth, and thus the area to be illuminated. The second cross-sectional shape may be selected in accordance with the needs of the particular application.

The cross-sectional shape of light tip 10 continuously and smoothly changes from the first cross-sectional shape to the second cross-sectional shape in at least a first portion of the light tip. In the illustrated embodiment, the cross-sectional shape of the light tip body gradually and smoothly changes along the entire length of the light tip, from the first cross-sectional shape at the proximal end of the first portion of the light tip to the second cross-sectional shape at the distal end of the light tip. In the illustrated embodiment, closer to the proximal end of the light tip, the cross sectional shape is very nearly circular, and may be in the form of an ellipse with its major and minor axes nearly equal. The cross section may continuously vary along the length of the light tip until reaching the elliptical form of the second cross-sectional shape. The cross-section may gradually, smoothly and continuously change in the form of an ellipse with the major axis gradually and smoothly increasing and the minor axis gradually and smoothly decreasing.

The cross sectional shape need not continuously vary along the entire length. For example, the cross sectional shape may be unchanged along a distal portion or a proximal portion of the light tip, or at one or more intermediate portions of the light tip. In embodiments where the cross sectional shape changes in a portion of the light tip, the cross sectional shape may vary smoothly and continuously through that portion of the light tip.

The cross-sectional surface area of the bundle at the proximal end is greater than the cross-sectional surface area of the bundle at the distal end as a result of the taper of at least some of the optical fibers making up the bundle. The cross-sectional surface area varies gradually and smoothly through any portion of the light tip in which the diameter of the optical fibers is decreasing. In the illustrated embodiment, the diameter of the optical fibers smoothly decreases though the entire length of the light tip, and the cross-sectional surface area varies gradually and smoothly through the entire length of the light tip.

In the illustrated embodiment, the light tip both gradually and smoothly changes along its entire length in cross-sectional area and cross-sectional shape. However, various combinations of smooth and continuous change of shape and area from the proximal aperture to the distal aperture are possible.

Within the bundle, the relative positions of the individual optical fibers change to accommodate the change in the shape of the cross-section.

The straight proximal section of light tip 10 has a central axis, shown as 30 in FIG. 2. The straight distal section of light tip 10 has a central axis 31. In the illustrated embodiment, the angle θ between proximal section central axis 30 and distal section central axis 31 may be about 60 degrees. The curvature may be changed as desired for different applications.

Collar 12 may have a circumferential notch 13 to provide a connection to a housing for a light source. Collar 12 may be of any rigid material that may be autoclaved, and may be of steel, for example.

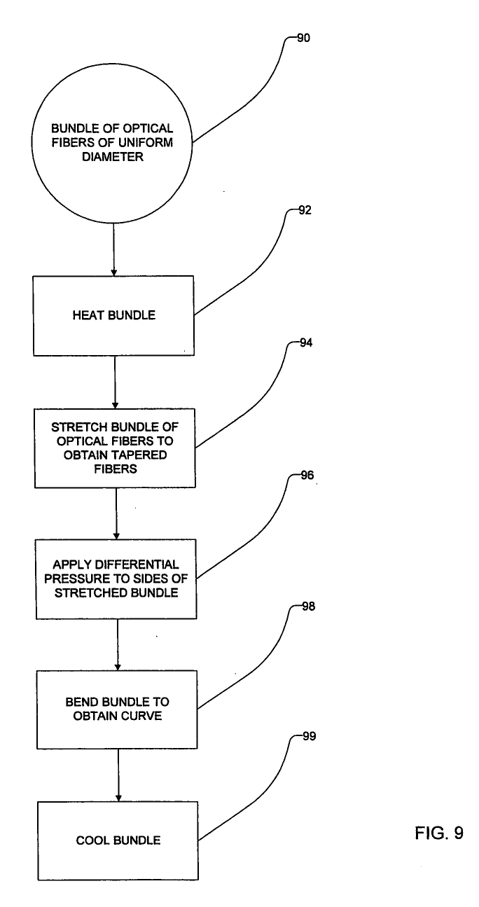

Referring now to FIG. 9, a method of making of a light tip in accordance with the invention will now be described. The method commences with a bundle of optical fibers of uniform diameter, as indicated at block 90. The bundle typically has a circular cross section. The bundle may then be heated, as indicated at block 92, and, while maintained at an elevated temperature, stretched to obtain a bundle of tapered fibers of uniform cross-section, as indicated at block 94. The bundle, while still maintained at an elevated temperature, may be formed into the desired shape by applying pressure differentially on the sides of the heated and stretched bundle, as indicated at block 96, to obtain the changing cross-section. The term “differential pressure” may refer either any one or more of: applying pressure of differing intensities at different locations on the sides of the bundle, or applying pressure of the same intensity for differing durations on the sides of the bundle. Pressure may be applied on opposing sides of the bundle to obtain the narrow axis of an ellipse, while the bundle moves outward to obtain the wider axis of the ellipse. For example, no pressure may be applied at the proximal end of the bundle, while pressure may be applied on two opposing sides for a selected period of time, with a relatively low pressure near the proximal end of the bundle, and gradually increasing until reaching a maximum at the distal end of the bundle. Upon obtaining the desired differential cross-section, the bundle is then bent, while still maintained at an elevated temperature, to obtain a curve, as indicated at block 98. The bundle may be bent so that a proximal portion is straight, a distal portion is straight, and an intermediate portion is curved, as illustrated in FIG. 2. After the step of curving the bundle, the bundle is cooled, as indicated at block 99. Those of ordinary skill in the art in the field of fabrication and manipulation of bundles of optical fibers will readily be able to select proper temperatures, stretching forces and pressures to obtain the desired bundle. Alternative techniques may be employed.

In one embodiment, the proximal aperture has a clear window with a diameter, dimension A of FIG. 2, of about 0.5 inches and hence a cross-sectional surface area of about 0.196 square inches, and the distal aperture has a cross-sectional surface area of about 0.077 square inches, with an elliptical shape having a major axis length of 0.415 inches and a minor axis length of about 0.215 inches. It will be appreciated that these dimensions can be varied.

Optical fibers are flexible and propagate light in a curved direction due to the total internal reflection of the light. In principle, other elongated light conductors having the same properties could be substituted for optical fibers.

Exemplary dimensions, referring to FIG. 2, may be between about 2 inches and about 5 inches, and about 3 inches, for dimension B, the overall length of light tip 10 measured parallel to the central axis, and between about 1.8 inches and about 4.6 inches, and about 2.8 inches, varying with the overall length of the light tip 10 and the curvature, for dimension C, the length from the proximal end of light tip 10 to the center of the distal end of the light tip. These dimensions may be varied by those of ordinary skill in the art.

An exemplary advantage of a light tip in accordance with the present invention is that the distal end may be formed to have a shape resembling the shape of an object on which it is desired to provide incident radiation. For example, an elliptical shape may resemble the shape of a tooth more closely than a circular shape resembles the shape of a tooth.

While the foregoing invention has been described with reference to the above, various modifications and changes can be made without departing from the spirit of the invention. Accordingly, all such modifications and changes are considered to be within the scope of the invention.

What is claimed is:

1. A light tip, comprising:
a bundle of elongated light conductors;
a sleeve about the bundle;
a proximal light transmitting aperture having a first cross-sectional shape at a proximal end of said bundle; and
a distal light transmitting aperture having a second cross-sectional shape at a distal end of said bundle.

2. The light tip of claim 1, wherein at least some of said elongated light conductors taper from a relatively larger diameter to a relatively smaller diameter from the proximal aperture to the distal aperture.

3. The light tip of claim 1, wherein a surface area of said proximal aperture is greater than a surface area of said distal aperture.

4. The light tip of claim 1, wherein a cross-sectional shape of said light tip smoothly and continuously changes from the first cross-sectional shape to the second cross-sectional shape through at least a first portion of said light tip.

5. The light tip of claim 1, wherein the light tip has a curved section and at least one straight section.

6. The light tip of claim 1, wherein said elongated conductors are optical fibers.

7. A method of making a bundle of elongated light conductors suitable for use as a light tip, comprising the steps of:
heating a bundle of elongated light conductors of uniform diameter;
stretching the bundle while heated to obtain tapered light conductors; and
applying differential pressure to the sides of the bundle while heated to obtain a varying cross-section.

8. The method of claim 7, further comprising, after said step of applying differential pressure, bending the bundle.

9. The method of claim 7, wherein the light conductors are optical fibers.

10. The method of claim 7, wherein said bundle has a distal end and a proximal end, and, upon completion of said step of applying, the bundle has a first cross-sectional shape at the proximal end and a second cross-sectional shape at the distal end.

11. The method of claim 10, wherein the first cross-sectional shape is circular and the second cross-sectional shape is elliptical.
